(19) United States
(12) Patent Application Publication
(10) Pub. No.: US 2006/0146581 A1
(43) Pub. Date: Jul. 6, 2006

(54) POWER DISTRIBUTION DEVICE

(75) Inventor: Michael P. Murphy, Solebury, PA (US)

Correspondence Address: GREGORY J. GORE, 70 WEST OAKLAND AVENUE, SUITE 316, DOYLESTOWN, PA, 18901, US

(73) Assignee: Rack Distribution Products, LLC, Bristol, PA (US)

(21) Appl. No.: 11/160,146

(22) Filed: Jun. 10, 2005

Related U.S. Application Data
(60) Provisional application No. 60/638,400, filed on Dec. 27, 2004.

(51) Int. Cl. H02M 5/45

(52) U.S. Cl. 363/37

(57) ABSTRACT

A rack power distribution system includes a unique configuration of electrical power wiring, branch circuit panels, branch circuit breakers, and three-phase power distribution devices packaged in the compound housing that mounts within standard EIA racks. The input side receives three-phase power, includes an input breaker and an optional maintenance bypass switch. The output side of the device utilizes multiple three-phase power output assemblies which can be connected to different breakout units designed to support several alternatives such as single phase power strips. As one option, the output may consist of a breakout cable consisting of a wiring harness with a three-phase plug at one end and one to three single phase receptacles of matching or lesser ampacity on the other end. The invention includes a housing which is provided with easily removed front and top panels and side-mounted rails/slides for a “draw out” type mounting in the rack.

### RELATED APPLICATIONS

The present application is related to provisional patent application Ser. No. 60/638,400 entitled “Power Distribution Device” filed on Dec. 27, 2004, priority from which is hereby claimed.

### FIELD OF THE INVENTION

The present invention generally relates to electrical power distribution apparatus. More particularly, it relates to a rack-mounted, electrical power distribution apparatus for computer and telecommunications equipment.

### BACKGROUND OF THE INVENTION AND PRIOR ART

Computing and telecommunications equipment technology is advancing very rapidly, resulting in constant turnover of servers, switches and other devices within a row of computer racks. This type of equipment is predominately powered through single phase 120 volt or 208 volt power cords, each requiring a matching receptacle for plug-in connection. When the telecommunication equipment is changed, the voltage and plug type often change at the same time, requiring an electrician to rewire the power distribution system. In recent years, the number of plugs has multiplied dramatically as the computing equipment is more often being supplied with two, three and even four power cords to provide redundant operation in the event of the failure of a single power supply. These constantly changing needs have in the past required a licensed electrician to provide a matching power supply circuit, hardwired to a local power distribution unit or wall mounted panel board. This continuous reconfiguration has resulted in an incomprehensible maze of electrical power cabling in computer facilities. Therefore, in computer and telecommunication centers, there is a need for an improved method and products that will accommodate these rapidly changing conditions without the need for electrical specialists.

The closest patent prior art of which the applicant is aware is U.S. Pat. No. 6,608,406 issued to Bersiek. This patent reference discloses a rack-mountable power distribution apparatus which provides for both hardwired or internal circuits simultaneously, each adapted to directly receive a specific plug from electrical equipment. This device, however, does not provide a convenient and flexible way to reconfigure the single phase power commonly used with rack-mounted computer equipment as it is upgraded or replaced in the field. Furthermore, it does not provide for the use of a field installed optional maintenance bypass switch. There is therefore a need in the art for a system that addresses these various problems.

### SUMMARY OF THE INVENTION

To meet the need in the art, a unique power distribution apparatus has been created that allows the end user to rapidly reconfigure the power distribution in a 19 or 23 inch EIA rack mounted equipment configuration without the help of an electrician or other tradesman. The system is cost effective, flexible and versatile. The present rack power distribution system consists of a unique configuration of electrical power wiring, branch circuit panels, branch circuit breakers and three-phase power distribution devices packaged in a compact housing that mounts within the aforementioned EIA racks.

Input to the system consists of a 120/208/240 volt single or three-phase power feed of 100 amps or greater capacity and utilizing a neutral conductor and a grounding conductor, commonly installed by an electrical tradesman. It further includes a configurable input design that allows field mounting of an optional input circuit breaker providing local short circuit protection to meet local electrical codes. The input breaker comes in a matching enclosure to the main housing and configured for field mounting to the main housing. This allows for cost effective application of the product and exact configuration of the system to the projects needs. In another adaptation, the invention can be provided with a field mounted maintenance bypass switch or other switching device that provides a “make before break” capability, enabling a maintenance bypass feature for safe and efficient maintenance of upstream uninterruptible power systems, power conditioning or distribution equipment without disturbing the critical computer loads.

The output side of the invention uses multiple three-phase power output assemblies of less than 100 amps which are most often connected to a standard breakout unit designed to support the final connection to single phase power strips. It utilizes multiple, three-phase output power distribution cords and breakout boxes, all of the same ampacity, connected in series to provide the user with the specific final receptacle configuration required to support the particular power strip desired to be mounted in the rack. Breakout units consist of one, three-phase input connector of less than 100 amp capacity with two or more single phase output receptacles of matching or lesser ampacity. As an option, a breakout cable consisting of a wiring harness with a three-phase plug on one end and one to three single phase receptacles of matching or lesser ampacity on the other can be used to provide the function of adapting from three-phase to single phase distribution, in lieu of the three-phase power distribution cords and breakout boxes. Alternately, a three-phase power strip with a connector of matching ampacity and configuration can be directly connected to the unit. Any and all requirements to hardwire equipment to the output devices are eliminated in the design of the system, and provide a “plug and play” feature for the user.

In a very unique application, without modification, this three-phase system can be used with a single phase UPS of a particular design that takes advantage of the three-phase nature of the invention. When used in this arrangement, the output power distribution cord is supplied with a three-phase plug on one end and one single phase receptacle on the other end. Depending on how the three-phase plug on the power cord is wired internally, the output receptacle can provide 120, 208 or 240 volt single phase power. By clearly marking these specialty cords, the end user can select and field modify the needed voltage by simply changing the cord on the output of the unit.

In another adaptation of the present rack distribution system, a power monitoring system can be provided to mount internal to the housing that monitors voltage, current, watts and/or VA on each individual branch circuit. This can be advantageous in alerting the user to potential overload conditions that often occur when plugging multiple pieces of telecommunications equipment into the rack mounted power strips served by this apparatus. Furthermore, for uninterrupted maintenance in a critical power application where the computer load cannot be allowed to shut down even for routine maintenance, the housing is provided with easily removed front and top panels, and side mounting rails/slides for a “draw out” type mounting in the rack. During maintenance, the housing can be pulled out from the rack, the top and front panels removed, and the unit scanned with an infrared camera to detect failing devices or equipment. When finished, the panels can be replaced and the unit pushed back into position without disturbing the load.

It is therefore an object of the invention to create a device which provides a convenient and flexible means for distributing single phase power in the environment of rack mounted computer equipment. It is further an object of the invention to provide a power distribution device which further utilizes a bypass switch to make maintenance more convenient and it is yet another object of the invention to provide a rack mounted power distribution device which does not require an internal transformer and is therefore more compact.

From the following drawings and description of the preferred embodiment, it will be appreciated by those of skill in the art that the objects of the invention have been achieved. While the present invention will be described with the reference to a specific embodiment, the following description is illustrative of the invention and is not to be construed as limiting the invention. Various modifications to the present invention can be made to the preferred embodiment by those skilled in the art without departing from the true spirit and scope of the invention. It will be noted here that for better understanding like components are designated by the reference numerals throughout the various figures of drawing which follow.

### DESCRIPTION OF THE DRAWINGS

FIG. 1 is a block circuit diagram of the apparatus.

FIG. 2 is a perspective view of the front of the invention.

FIG. 3 is a perspective view of the invention.

### DESCRIPTION OF THE PREFERRED EMBODIMENT

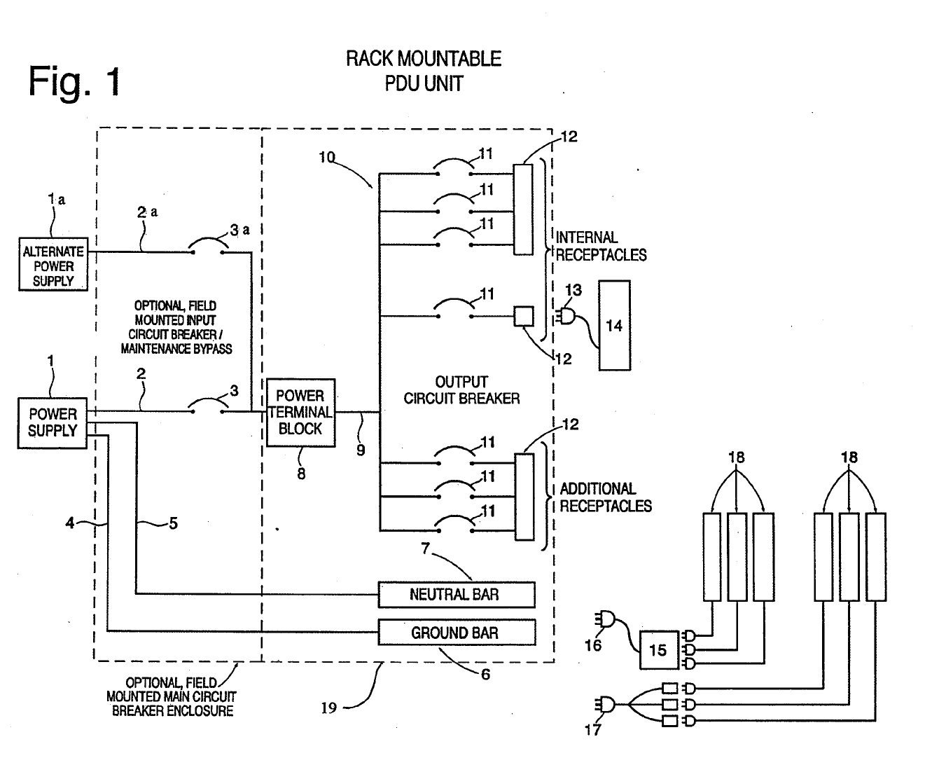

FIG. 1 is a block circuit diagram of the apparatus and its accessories demonstrating various connection configurations for the system including breakout boxes, three-phase output power distribution cords, wiring harnesses and power strips. Also shown is the optional field mountable input circuit breaker and maintenance bypass options. The device is designed to receive power from a 120/208/240 volt utility or uninterruptible power supply (UPS) 1 through a three-phase electrical input assembly consisting of terminal blocks and power wiring 2 of 100 amps or greater capacity contained within a single housing 19. The three-phase system may also be used with certain single phase UPS to provide multiple output voltages for the end user. In addition to the power wiring, the input also consists of an incoming neutral conductor 5, neutral terminal block 7, ground conductor 4 and ground terminal block 6 as is required by the National Electrical Code and otherwise prudent electrical design practices. In the configuration shown, the input power wiring connects directly into the optional input circuit breaker 3, otherwise connecting directly into the three-phase power terminal block 8. From this terminal block, internal wiring 9 within the housing provides a direct connection to a three-phase branch circuit panel board 10 that provides multiple single phase branch circuit breaker connections 11 of reduced ampacity compared to the input.

Optionally, a field-mounted input circuit breaker may be utilized as a convenient maintenance bypass device. With this configuration, an alternate power supply 1a may be connected through input line 2a to an alternate circuit breaker 3a. This provides for the safe and efficient maintenance of upstream uninterruptible power systems, power conditioning, or distribution equipment without disturbing the critical computer loads. The input circuit breakers may be mounted within a main circuit breaker enclosure (not shown) which is directly adjacent to the main distribution unit housing.

Each set of three, single phase branch circuit breakers connects to a three-phase receptacle 12 that also contains its own neutral and ground connection to the grounding terminal block 6 and the neutral terminal block 7. Each conductor in the three-phase circuit is individually protected with these single phase breakers. From this point in the apparatus multiple options exist for configuring the output power distribution to the exact needs of the end user. In one implementation a three-phase power strip 14 with a matching three-phase plug 13 may be plugged directly into the unit.

In another implementation, a three-phase wiring harness 16 with a three-phase plug and receptacle of matching ampacity and prong configuration is used to connect to a single phase breakout box 15 consisting of a three-phase input and two or more single phase output connectors. The simple connections within the breakout boxes will be obvious to those of skill in the art and therefore need not be shown. One or more single phase power strips 18 may be plugged into each breakout box. Three-phase wiring harnesses or power output cords may be color coded to allow easy tracing of the wiring within the racks.

In yet another configuration, a three-phase to single phase wiring harness 17 with a three-phase plug and two or more single phase receptacles of matching ampacity is used to connect to two or more single phase output connectors. One single phase power strip 18 may be plugged into each single phase output receptacle on the wiring harness.

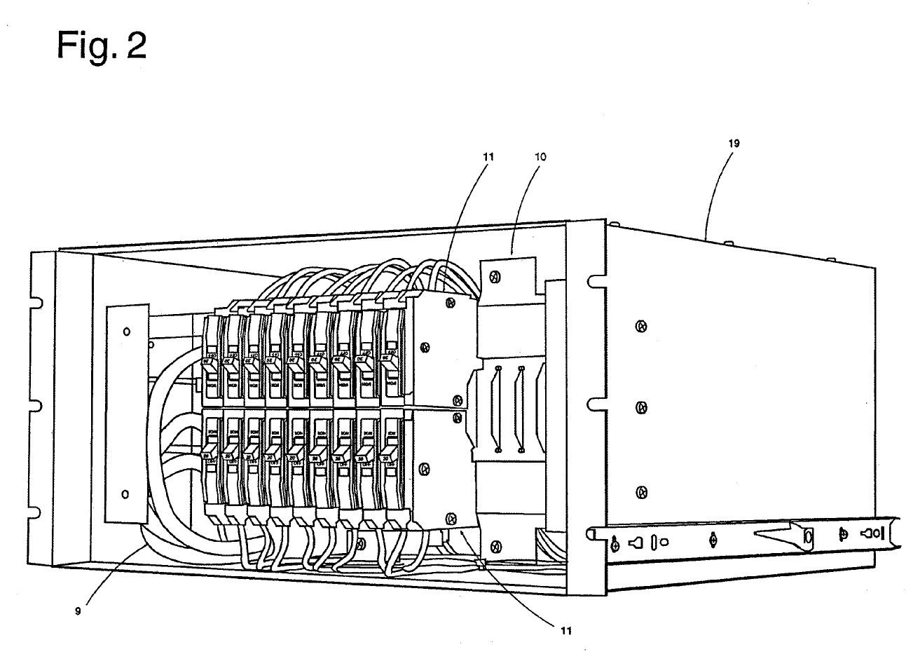

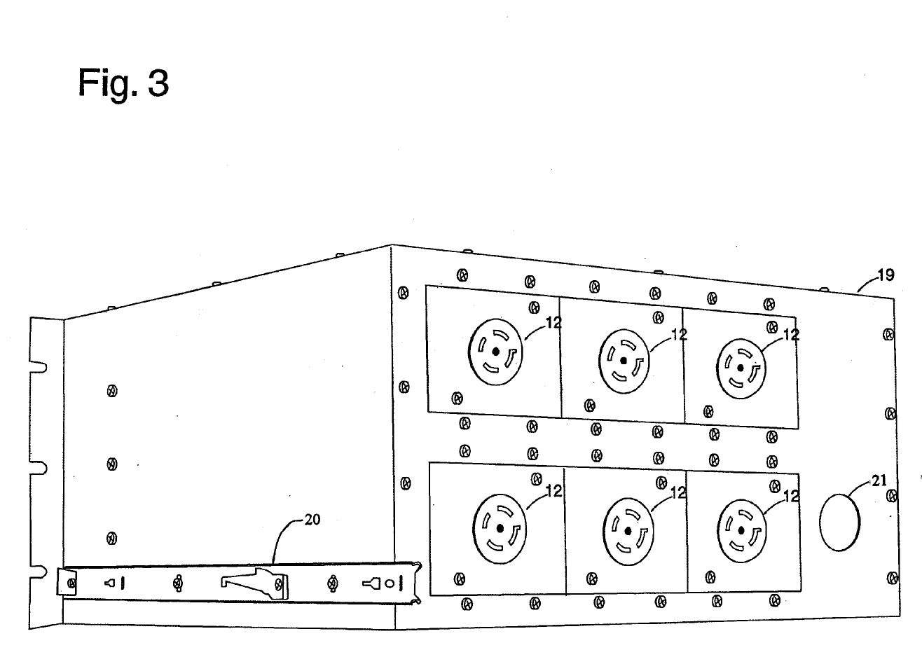

Referring now to FIGS. 2 and 3, FIG. 2 is a perspective view of the front of the rack distribution system having a housing 19 with the front cover removed showing the input wiring 9, branch circuit panel board 11, branch circuit breakers, and partial output wiring. FIG. 3 is a perspective view of the rear of the housing 19 showing the rack draw out mounting slides 20, input wiring access point 21 and multiple three-phase output receptacles 12.

Thus, the invention provides distribution of computer grade electrical power in a low profile, compact configuration within standard EIA 19″ and 23″ equipment racks. It provides the ability for a telecommunications or computer equipment end-user to rapidly and easily reconfigure the power distribution within his racks without the need of a trained electrician. The system provides a standardized set of three-phase twist lock output receptacles to connect to intermediate devices and then to power strips, or directly to three-phase power strips. When used with system breakout boxes, the three-phase power may be segregated into single phase power. Thus, it is not contemplated that the invention have computer equipment plugged directly into it but rather only into a system breakout box, breakout cable, or three-phase power strips. It is an intermediate distribution system with highly standardized twist lock output receptacles that provide flexibility in the field.

While various specific embodiments have been depicted, it should be understood that there may be other modifications and changes to the present invention that will be obvious to those of skill in the art from the foregoing description, however, the present invention should be limited only by the following claims and their legal equivalents.

What is claimed is:

1. An electrical power distribution system, comprising:
a main housing mounted on a rack;
a circuit panel within said housing for receiving electrical power input from a three-phase commercial power supply source, said circuit panel comprising a plurality of single phase branch circuit breakers; and
a plurality of three-phase electrical power output receptacles in said housing wired to said branch circuit breakers for receiving plug-in connections to a plurality of electrical output power assemblies, each assembly including at least one output receptacle structured to receive an equipment plug to provide electrical power thereto.

2. The electrical power distribution system of claim 1 wherein said power output assemblies are breakout boxes wired to convert three-phase power from said output receptacles to single phase power connected to a single phase power strip for plug-in equipment connection.

3. The electrical power distribution system of claim 2 further including a bypass circuit comprising two input switching devices connected in parallel between said commercial power supply source and said input circuit panel such that an alternate power supply can be connected to an alternate input line through an alternate switching device.

4. The electrical power distribution system of claim 1 wherein said branch circuit breakers are of reduced ampacity compared to the commercial power supply input.

5. The electrical power distribution system of claim 3 wherein said input circuit breakers are located within a demountable main circuit breaker enclosure adjacent to said housing.

6. The electrical power distribution system of claim 1 wherein said housing is mounted on slides which are affixed to said rack.

7. The electrical power distribution system of claim 1 wherein said output receptacles are three-phase twist lock receptacles.

8. The electrical power distribution system of claim 3 wherein at least one of said switching devices is a circuit breaker.

9. The electrical power distribution system of claim 2 wherein said breakout boxes are contained in a second housing demountable from said main housing.

10. The electrical distribution system of claim 2 further including an output power distribution cord having a three-phase plug on one end and a single phase receptacle on the other end whereby 120, 208 or 240 volt single phase power is selectable by changing differently wired cords.
